(19) United States
(12) Patent Application Publication
(10) Pub. No.: US 2013/0113237 A1
(43) Pub. Date: May 9, 2013

(54) Method of Manufacturing a Vehicle Structural Pillar

(71) Applicant: Henrik Huhn, Dusseldorf (DE)

(72) Inventor: Henrik Huhn, Dusseldorf (DE)

(73) Assignee: Ford Global Technologies, LLC, Dearborn, MI (US)

(21) Appl. No.: 13/662,446

(22) Filed: Oct. 27, 2012

(30) Foreign Application Priority Data
Nov. 2, 2011 (DE) 102011085590.4

(51) Int. Cl. B62D 25/04; B21D 53/88; B62D 25/02

(52) U.S. Cl. CPC B62D 25/04; B62D 25/02; B21D 53/88
USPC 296/193.05; 296/193.06; 29/897.2

(57) ABSTRACT

A method of manufacturing a vehicle structural pillar, includes: forming an inner panel with a first flange; forming an outer panel with a second flange; and clinching the second flange over the first flange so as to secure the inner panel and outer panel together by the first and second flanges.

### CROSS-REFERENCE TO RELATED APPLICATIONS

This application is a continuation and claims the benefit of German Patent Application No. DE 102011085590.4 titled “Body member of a vehicle body, in particular a B-pillar,” filed Nov. 2, 2011, which is hereby incorporated in its entirety.

### TECHNICAL FIELD

The present disclosure relates to a body member of a vehicle body, for example a B-pillar, and methods for manufacturing the same.

### BACKGROUND

In vehicle body construction thermal joining methods, such as resistance spot-welding, are used when assembling flanges of the panels, sometimes in combination with adhesive bonding methods or laser welding. However, the increasingly popular use of high-strength and ultra high-strength steels for stiffening components in A-pillars and B-pillars, for example, can make connecting the flanges more complicated. Also complications arise when welding together mixed construction assemblies, such as welding steel with a light alloy material, for example.

Therefore it is desirable to provide a body member, such as a vehicle structural member, having flanges connected by less complicated, yet more efficient means.

### SUMMARY

The present disclosure addresses one or more of the above-mentioned issues. Other features and/or advantages will become apparent from the description which follows.

One exemplary embodiment of the present disclosure relates to a method of manufacturing a vehicle structural pillar, the method including: forming an inner panel with a first flange; forming an outer panel with a second flange; and clinching the second flange over the first flange so as to secure the inner panel and outer panel together by the first and second flanges.

Another exemplary embodiment of the present disclosure relates to a vehicle side panel, having: a structural pillar assembly, including: an inner panel with a first flange; and an outer panel with a second flange. The first and second flanges are clinched together.

One exemplary embodiment of the present disclosure relates to a vehicle structural pillar assembly, having: an outside panel; and an enclosed panel, laterally and continuously connected to the outside panel by way of respective flanges. A flange of one of the outside or enclosed panels wraps around a flange of the other of the outside or enclosed panels to form a positive interlock at least in some sectors of the outside and enclosed panels.

Another exemplary embodiment of the present disclosure relates to a side wall of a motor vehicle, having: a body member arranged in a door opening, the body member including: an outside panel; and an enclosed panel connected to the outer panel by way of respective flanges. A flange of one of the outside or inside panels wraps around a flange of the other of the outside or inside panels to form a positive interlock at least in some sectors of the outside and enclosed panels.

One advantage of the present teachings is that simple a positive interlock for body panels in vehicle structural members is achieved.

The invention will be explained in greater detail below by way of example with reference to the figures, in which the same reference numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 shows a side view of a vehicle B-pillar.

FIG. 2 shows the B-pillar of FIG. 1 at section X.

FIGS. 3a and 3b show partial cross sectional views of unseamed and seamed flanges, respectively, according to a section profile at A-A in FIG. 2;

FIGS. 4a to 4d show partial cross sectional views of another B-pillar according to an exemplary design.

FIGS. 5a and 5b show partial cross sectional views of another B-pillar according to an exemplary design.

FIG. 6 illustrates another exemplary embodiment of a B-pillar having various connecting areas.

FIGS. 7a and 7b show partial cross sectional views of the B-pillar of FIG. 6 according to section profile B-B and section profile C-C, respectively.

FIG. 8 shows a partial cross sectional view of another exemplary vehicle structural pillar.

FIG. 9 shows a side view of a side wall of a vehicle with exemplary body members in a door entry area.

FIGS. 10a to 10d show cross-sectional views through the body members of FIG. 9 at section profile A-A, section profile B-B, section profile C-C and section profile D-D, respectively.

### DETAILED DESCRIPTION

Referring to the drawings, wherein like characters represent examples of the same or corresponding parts throughout the several views, there are shown exemplary embodiments of a vehicle structural pillar. The vehicle structural pillar can be any structural pillar in the vehicle, including, for example the A-pillar, B-pillar, C-pillar or D-pillar. The structural pillars can be formed using a clinching or hem-lock procedure where a flange on an outer panel is wrapped around a flange on an inner panel, or vice versa.

In one embodiment a stiffening plate flange, at least in some sectors, can be arranged inwardly offset relative to the other two flanges. Here the stiffening plate flange can be connected to the inside panel flange, in particular by means of laser welding, in the areas in which the stiffening plate is arranged inwardly offset relative to the other two flanges. The inside panel flange can overlap the stiffening plate flange and internally bear flatly against the outside panel flange, which by bending over in turn encloses it with a positive interlock.

In another embodiment of the body member, the outside panel flange wraps around the stiffening plate flange and/or the inside panel flange to form a positive interlock at least in some sectors, in particular by means of beading. In the embodiment of the body member in which the outside panel flange wraps around the inside panel flange to form a positive interlock at least in some sectors, the stiffening plate flange is arranged inwardly offset relative to the other two flanges, at least in the sectors where the outside panel flange is beaded around the inside panel flange.

In another embodiment of the body member the inside panel flange is recessed in some sectors and connected to the stiffening plate flange in non-recessed areas. Here the inside panel flange and the stiffening plate flange can be adhesively bonded together.

In another exemplary embodiment of the body member, the outside panel flange and the inside panel flange are alternately recessed, at least in some sectors. Here a mechanical advantage accrues if the outside panel flange and the inside panel flange can wrap alternately around the stiffening plate flange to form a positive interlock, in each case preferably in their non-recessed areas.

The outside panel flange can wrap around, and in particular be beaded around, the stiffening plate flange and/or the inside panel flange to form a positive interlock at least in some sectors. Here the stiffening plate flange and the inside panel flange are arranged flatly continuous with one another. This embodiment of the body member is advantageous, since in this way all three flanges can be connected together in one operation. It can be used to particular advantage in the case of flanges which have a small overall thickness.

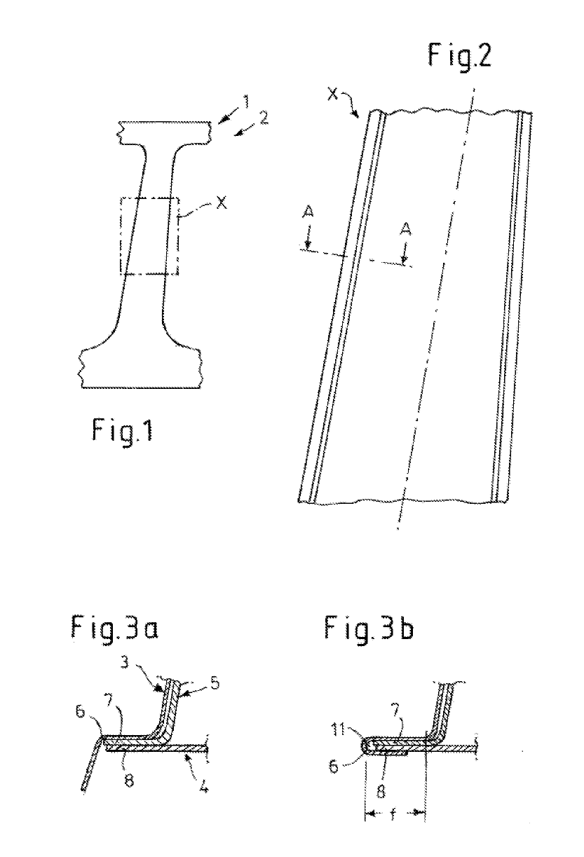

Referring now to the figures, FIGS. 1 to 8 show different views and details of a body member 2, here embodied as a B-pillar 1. As can be seen, in particular, from the partial sectional views according to FIGS. 3, 4, 5 and 7, the body member 2 comprises an outside panel 3, an inside panel 4 and a stiffening plate 5 arranged between the outside panel 3 and the inside panel 4. The panels 3 to 5 are laterally continuously connected to one another via respective flanges 6-8. An outside panel flange 6 of the outside panel 3, an inside panel flange 8 of the inside panel 4 and a stiffening flange 7 of the stiffening plate 5 are connected, in that, for example, the outside panel flange 6 wraps around at least the stiffening flange 7 to form a positive interlock.

FIGS. 3a and 3b, each illustrate a partial sectional view according to section profile A-A in FIG. 2. There is illustrated a process of wrapping around on flange over the other, in particular beading, in two steps of the method. FIG. 3a shows the outside panel flange 6, which is prepared for flanging and is bent off at an end. In a further step of the method the outside panel flange 6 is flanged or bent over around continuous flanges 7 and 8, until the outside panel flange 6 at a bottom bears against the inside panel flange 8 and thereby wraps around the other two flanges 7 and 8 to form a positive interlock.

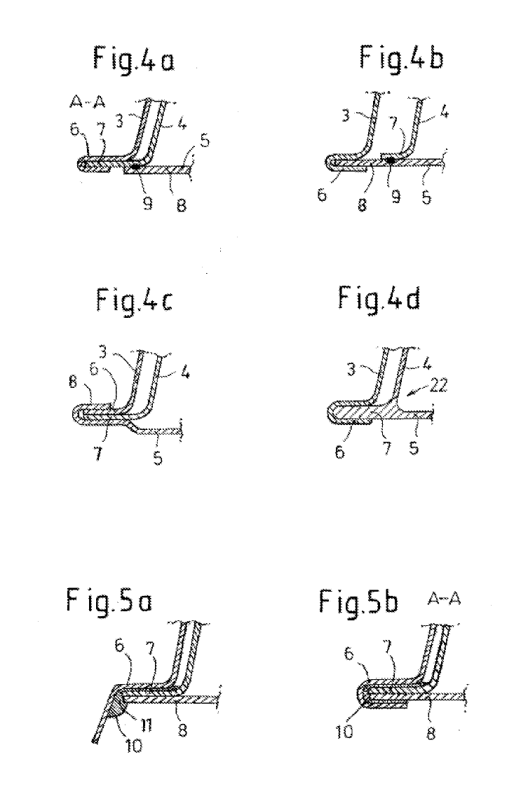

FIGS. 4a to 4c each show a design variant with reference to a partial sectional view according to a similar section profile A-A according to FIG. 2. As shown in FIG. 4a, the inside panel flange 8 is arranged laterally set back relative to other flanges 6, 7. In this case set back is accomplished by means of cutting back. The outside panel flange 6 alone wraps round the stiffening plate flange 7 to form a positive interlock. Furthermore the inside panel flange 8 and the stiffening plate flange 7 in FIG. 4a are connected together by means of welds 9.

In FIG. 4b a stiffening plate flange 7 is arranged laterally set back relative to the other flanges 6, 8, in this case by means of cutting back, so that the outside panel flange 6 alone wraps around the inside panel flange 8 to form a positive interlock. Here, as in FIG. 4a, the inside panel flange 8 and the stiffening plate flange 7 are connected by welds 9.

In FIG. 4c the outside panel flange 6 and the stiffening plate flange 7 are wrapped by the inside panel flange 8. In this variant the inside panel flange 8 is bent outwards; the direction of flanging differs from the variants shown previously.

FIG. 4d shows the beading of a stiffening plate flange 7 by the outside panel flange 6. The stiffening plate flange 7 is a part of a member profile 22, which has been produced, for example, by hydro-forming, injection molding or as a fiber composite forming process. The stiffening plate 5 and the inside panel 4 are then integrally formed as part of the member profile 22. Here it is advantageously possible to combine different materials for the panel parts. The member profile 22 can be composed of a cast aluminum material, the outside panel 3 can be composed of steel.

FIGS. 5a and 5b show a further variant for connecting the flanges 6-8. In this embodiment, the flanges 6-8 are additionally adhesively bonded together. For this purpose, before bending over fully according to FIG. 5b, adhesive 10 is applied internally to the outside panel flange 6 and is distributed in this case over the upper side of the stiffening plate flange 7 and the underside of the inside panel flange 8 as the outside panel flange 6 is bent over. Here the adhesive 10 takes the form of a structural adhesive, which is also used to fill gaps 11, as illustrated in FIG. 5b.

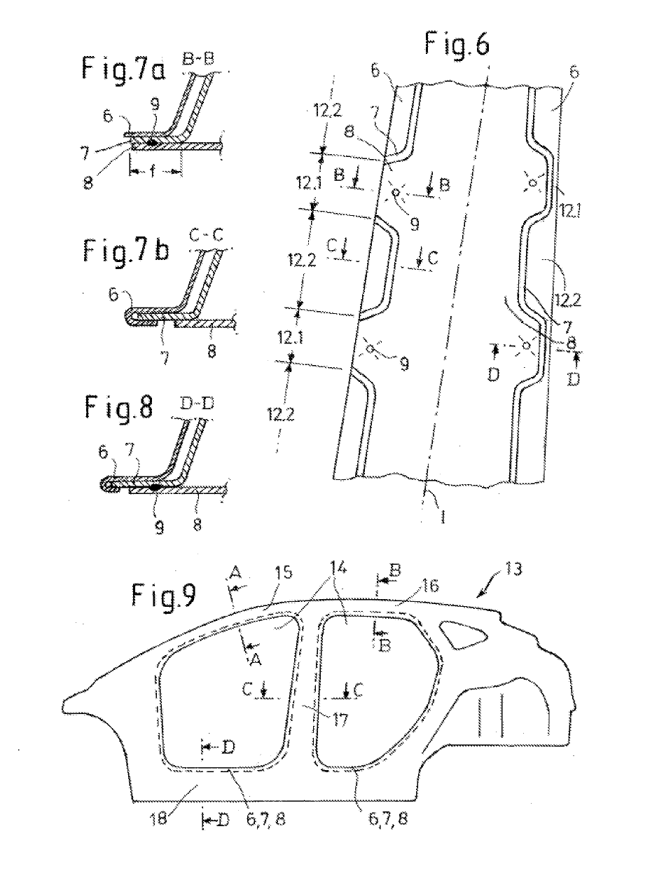

FIG. 6 shows a side view of another embodiment of the body member 2, here in the form of a B-pillar 1. Two different connecting areas, a first connecting area 12.1 and a second connecting area 12.2, are arranged alternating with one another over a longitudinal extent 1 of the B-pillar 1. In the first connecting area 12.1 a stiffening plate flange 7 and the inside panel flange 8 are welded together by means of resistance welding, which is shown in FIG. 7a, a sectional representation according to the section profile B-B with the weld area 9. As can be seen from the sectional representation in FIG. 7b, according to the section profile C-C, the inside panel flange 8 in the second connecting area 12.2 is arranged laterally set back relative to the other flanges 6, 7. That is to say inside panel is recessed in the second connecting area 12.2. The outside panel flange 6 in the second connecting area 12.2 wraps around the stiffening plate flange 7 to form a positive interlock, while a portion of the inside panel flange, remains unattached and bears internally against the stiffening plate flange 7. This is possible because the inside panel flange 8 is connected to the stiffening plate flange 7 in the first connecting area 12.1. The inside panel flange 8 is thereby connected to the stiffening plate flange 7 in the first connecting area 12.1 and the stiffening plate flange 7 and the outside panel flange 6 are connected together in the second connecting area 12.2, in an alternating sequence. Where the connecting areas 12.1, 12.2 provided are of small dimensions, a rapid succession of these different connections between the flanges 6-8 is obtained in the longitudinal extent 1 of the B-pillar 1, which overall allows a good connection of the flanges 6-8.

A further embodiment of the body member 2 of FIG. 6 is represented by a section D-D, which is shown enlarged in FIG. 8. Compared to the embodiment of the body member 2 according to FIG. 7a, the inside panel flange 8 in the first connecting area 12.1 is arranged set back relative to the other two flanges 6, 7 and is welded to the inside panel flange 8. In the second connecting area 12.2 the inside panel flange is recessed so that the outside panel flange 6 has a longer wrap-around. A continuous wrap-around of the stiffening plate flange 7 through the outside panel flange 6 is thereby obtained, resulting in a continuous flanged edge. This is advantageous.

FIG. 9 shows a side view of a side wall 13 with multiple body members in the door entry areas 14, in various possible ways of connecting the flanges 6 to 8, as described above. The A-pillar 15 in the area of the windshield, the roof frame 16 in the area of the rear door, the B-pillar 17 and the side sill 18 are here embodied as body members.

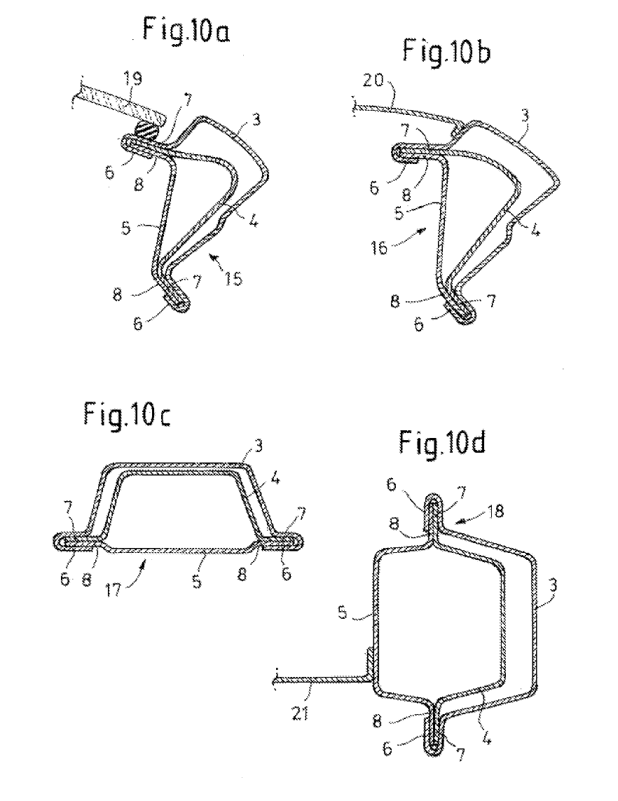

FIGS. 10a to 10d show schematic sections through the body members in FIG. 9. In all cases the outside panel flanges 6 of the uniform outside panel 3 are flanged around the stiffening plate flanges 7 and the inside panel flanges 8. In contrast to the outside panel 3, the stiffening plates 5 and the inside panels 4 here are not uniform, but are different panels in each of the various body members 15 to 18.

FIG. 10a shows section A-A through the A-pillar 15 in the area of the windshield 19. FIG. 10b shows the section B-B through the roof frame 16 with the roof panel 20. FIG. 10c shows the section C-C through the B-pillar 17 and FIG. 10d shows the section D-D through the side sill 18 with the floor panel 21.

A method of connection through a positively interlocking wrap-around is moreover suitable for mixed construction components in a vehicle body, such as steel/aluminum, steel/magnesium, steel/fiber composite and aluminum/fiber composite. Even in a mixed construction with a panel having a carbon fiber or glass fiber-reinforced structure as a stiffening plate or as an outside panel, can be connected to a cold-formable outside panel or stiffening plate by wrapping the latter panel or plate round to form a positive interlock.

The positively interlocking wrap-around can be executed by roller-seaming, for example, by rolling the flanges together. It can also be executed as a turnover in the form of a doubling of the thickness of the flange, the turnover of the flange of one panel receiving that of the other panel. This may also be referred to as flanging or beading. Connection can be formed, for example, by means of the wrap-around flange, at least in some sectors, or bending one flange over around the other flange, or in the case of a connection of more than two flanges, by wrapping laterally around so that it bears bilaterally on the wrapped flange or at the top and bottom on a stack of the wrapped flanges to form a positive interlock.

By connecting one panel to the other panel by means of flanging or seaming, it is possible to reduce a necessary flange length significantly compared to the flange length needed for resistance spot-welding, so that, for example, each associated door entry area can be designed larger.

A plastic material, advantageous for vibration-damping and/or sound-proofing, can be provided internally between the outside panel flange and the other flanges.

The connection, in particular the positively interlocking connection made by wrapping around, can preferably be performed in sectors. For example, the inside panel flange, at least in some sectors, can be arranged inwardly offset relative to the other two flanges. Here the inside panel flange can be connected to the stiffening plate, by means of laser welding, in the areas in which it is arranged inwardly offset relative to the other two flanges. In contrast to the generally thinner outside panel, the stiffening plate and the inside panel flange can have similar wall thicknesses, so that a good connection of the stiffening plate and the inside panel flange can be made by welding. Here the outside panel flange can wrap laterally around the stiffening plate flange to form a positive interlock, as described above. This combined connection formed by wrapping the outside panel flange around the stiffening plate flange to form a positive interlock, and welding the stiffening plate flange and the inside panel flange together is particularly advantageous in the case of larger sheet metal thicknesses of the stiffening plate and the inside panel.

Those familiar with the art to which this invention relates will recognize various alternative designs and embodiments for practicing the invention within the scope of the appended claims.

We claim:

1. A method of manufacturing a vehicle structural pillar, comprising:
forming an inner panel with a first flange;
forming an outer panel with a second flange; and
clinching the second flange over the first flange so as to secure the inner panel and outer panel together by the first and second flanges.

2. The method of claim 1, further comprising:
adhering the first and second flanges together.

3. The method of claim 1, further comprising:
laser welding the first and second flanges together.

4. The method of claim 1, further comprising:
forming a recess in the inside panel.

5. The method of claim 4, wherein clinching the second flange over the first flange is performed in a non-recessed area of the inside panel.

6. The method of claim 4, wherein clinching the second flange over the first flange is performed in a recessed area of the inside panel.

7. A vehicle side panel, comprising:
a structural pillar assembly, including:
an inner panel with a first flange; and
an outer panel with a second flange;
wherein said first and second flanges are clinched together.

8. The vehicle side panel of claim 7, comprising:
a recess formed in the inside panel flange.

9. A vehicle structural pillar assembly, comprising:
an outside panel; and
an enclosed panel, laterally and continuously connected to the outside panel by way of respective flanges;
wherein a flange of one of the outside or enclosed panels wraps around a flange of the other of the outside or enclosed panels to form a positive interlock at least in some sectors of the outside and enclosed panels.

10. The assembly of claim 9, wherein the flanges are interlocked through a flanging or seaming process.

11. The assembly of claim 9, wherein the enclosed panel includes a stiffening plate having a stiffening plate flange.

12. The assembly of claim 11, wherein the enclosed panel is an inside panel having the inside panel flange.

13. The assembly of claim 12, wherein the outside panel flange and inside panel flange are adhesively bonded.

14. The assembly of claim 11, wherein the inside panel flange, at least in some sectors, is arranged laterally set back relative to the outside panel flange and wherein the inside panel flange is connected to the stiffening plate by laser welding.

15. The assembly of claim 11, wherein the stiffening plate flange, at least in some sectors, is arranged laterally set back from the outside panel flange and wherein the stiffening plate flange is connected to the inside panel by laser welding.

16. The assembly of claim 11, wherein the inside panel flange is recessed in some sectors and connected to the stiffening plate flange in a non-recessed area.

17. The assembly of claim 11, wherein the outside panel flange wraps at least partially around the stiffening plate flange in an area where the inside panel flange is recessed.

18. The assembly of claim 9, wherein the outside panel flange and an enclosed panel flange are adhesively bonded.

19. A side wall of a motor vehicle, comprising:
a body member arranged in a door opening, the body member including:
an outside panel; and
an enclosed panel connected to the outer panel by way of respective flanges;
wherein a flange of one of the outside or inside panels wraps around a flange of the other of the outside or inside panels to form a positive interlock at least in some sectors of the outside and enclosed panels.

20. The side wall of claim 19, wherein at least one flange of the body member wrapped to form a positive interlock is further configured to receive a door seal.
